(19) United States
(12) Patent Application Publication
(10) Pub. No.: US 2018/0339286 A1
(43) Pub. Date: Nov. 29, 2018

(54) POLYMER-SUPPORTED CHELATING AGENT

(71) Applicant: QATAR FOUNDATION FOR EDUCATION, SCIENCE AND COMMUNITY DEVELOPMENT, DOHA (QA)

(72) Inventors: HASSAN SAID BAZZI, DOHA (QA); MOHAMMED AL-HASHIMI, DOHA (QA); DAVID E. BERGBREITER, COLLEGE STATION, TX (US); DALILA CHOUIKHI, DOHA (QA)

(21) Appl. No.: 15/980,680

(22) Filed: May 15, 2018

Related U.S. Application Data
(60) Provisional application No. 62/511,327, filed on May 25, 2017.

(51) Int. Cl. B01J 20/26; B01J 20/30; C08F 8/34; C22B 3/00; C22B 7/00; C22B 15/00; C22B 3/16

(52) U.S. Cl. CPC B01J 20/265; B01J 20/3085; C08F 8/34; C22B 3/1616; C22B 7/009; C22B 15/0065; C22B 11/048

(57) ABSTRACT

The polymer-supported chelating agent is polyisobutylene having a thiol-thioether terminal group. The polymer-supported chelating agent is made by reaction of the terminal carbon double bond of polyisobutylene with 1,2-ethanedithiol in a one-step click reaction, resulting in PIB functionalized with a thiol-thioether sequestering group. In use, the polymer-supported chelating agent is added to a biphasic solvent system containing a transition metal in solution for removal of the transition metal by liquid/liquid extraction. The transition metal is chelated or sequestered by the chelating agent and removed in a nonpolar organic phase, such as heptane.

### CROSS-REFERENCE TO RELATED APPLICATION

This application claims the benefit of U.S. Provisional Patent Application Ser. No. 62/511,327, filed May 25, 2017.

### BACKGROUND

### 1. Field

The disclosure of the present patent application relates to chemical separations, and particularly to a polymer-supported chelating agent for recovering a transition metal catalyst from a reaction mixture.

### 2. Description of the Related Art

While catalysis is a key aspect of green chemistry and while homogeneous catalyzed processes using transition metals are now commonly used in synthesis of most drugs and chemical intermediates, the separation of the metal catalysts or their by-products from the desired products remains a problem. This issue has been addressed in a variety of ways. The established approach to address this problem is to use solid state sequestrants. There is an immense arsenal of ion exchange resins and functionalized inorganic supports that can sequester metals or metal catalyst residues. As insoluble solids, these materials have the advantage that they can be easily physically separated from product solutions. However, they are generally only effective when the solution components and the sequestrant can be intimately mixed. A crosslinked polystyrene resin with a covalent sequestrant that does not have solvent swellability is simply ineffective. In other cases, the transition metal catalysts decompose into insoluble metal colloids and interactions of these colloidal particles with solid supports can be ineffective, either because of the physical limitations of solid-solid interactions, or because other ligands present in the mixture compete with the sequestrating agent

Thus, a polymer-supported chelating agent solving the aforementioned problems is desired.

### SUMMARY

The polymer-supported chelating agent is polyisobutylene having a thiol-thioether terminal group. The polymer-supported chelating agent is made by reaction of the terminal carbon double bond of polyisobutylene with 1,2-ethanedithiol in a one-step click reaction, resulting in PIB functionalized with a thiol-thioether sequestering group. In use, the polymer-supported chelating agent is added to a biphasic solvent system containing a transition metal in solution for removal of the transition metal by liquid/liquid extraction. The transition metal is chelated or sequestered by the chelating agent and removed in a nonpolar organic phase, such as heptane.

The one-step click reaction avoids the multistep synthesis typically required to make polymer-bound catalysts that are soluble in organic solvents. In model experiments, a range of transition metal salts of Co²⁺, Ni²⁺, Cu²⁺, Pd²⁺ and Ru³⁺ were successfully extracted from aqueous or polar organic solutions into immiscible heptane solution of a PIB-bound thioether-thiol sequestrant. This PIB derivative demonstrated an excellent performance with quantitative metal complexation in many cases. This functional polymer is efficient even in the presence of competing ligands that are typically used in homogeneous catalysis. In addition, this sequestrant was successfully used for treatment of aqueous and polar organic solutions of crude product mixtures obtained in model Pd-catalyzed Suzuki and Buchwald-Hartwig cross-coupling reactions, as well as in a Cu(I)-catalyzed alkyne/azide cyclization (CuAAC) reaction.

These and other features of the present disclosure will become readily apparent upon further review of the following specification and drawings.

### BRIEF DESCRIPTION OF THE DRAWINGS

FIG. 1 is a reaction scheme for the synthesis of a polymer-supported chelating agent.

FIG. 2 is the ¹H NMR spectrum of the polymer-supported chelating agent synthesized according to the reaction scheme of FIG. 1.

FIG. 3 is the ¹³C NMR spectrum of the polymer-supported chelating agent synthesized according to the reaction scheme of FIG. 1.

FIG. 4 is the ¹H NMR spectrum of the polymer-supported chelating agent of FIG. 1 mixed with the unwanted byproduct, compound 2.

FIG. 5 is a diagrammatic reaction scheme for the reaction of palladium acetate with the polymer-supported chelating agent of FIG. 1, showing the inventors' proposed explanation for the chelation of palladium.

FIG. 6 is a composite of ¹H NMR spectra for the titration of the polymer-supported chelating agent of FIG. 1 by palladium acetate, showing the concentration of Pd(OAc)₂ at (i) 0 eq.; (ii) 0.2 eq.; (iii) 0.5 eq.; (iv) 1 eq.; and (v) 2 eq., signal assignments for the peaks being shown in FIG. 2.

FIG. 7 are reaction schemes of Suzuki cross-coupling reactions tested for transition metal catalyst removal by the polymer-supported chelating agent of FIG. 1.

FIG. 8 are reaction schemes of Buchwald-Hartwig Amination reactions tested for transition metal catalyst removal by the polymer-supported chelating agent of FIG. 1.

FIG. 9 is a reaction scheme for a copper-catalyzed azide-alkyne cycloaddition reaction tested for transition metal catalyst removal by the polymer-supported chelating agent of FIG. 1.

Similar reference characters denote corresponding features consistently throughout the attached drawings.

### DETAILED DESCRIPTION OF THE PREFERRED EMBODIMENTS

The polymer-supported chelating agent is polyisobutylene having a thiol-thioether terminal group. The polymer-supported chelating agent is made by reaction of the terminal carbon double bond of polyisobutylene with 1,2-ethanedithiol in a one-step click reaction, resulting in PIB functionalized with a thiol-thioether sequestering group. In use, the polymer-supported chelating agent is added to a biphasic solvent system containing a transition metal in solution for removal of the transition metal by liquid/liquid extraction. The transition metal is chelated or sequestered by the chelating agent and removed in a nonpolar organic phase, such as heptane.

The one-step click reaction avoids the multistep synthesis typically required to make polymer-bound catalysts that are soluble in organic solvents. In model experiments, a range of transition metal salts of Co²⁺, Ni²⁺, Cu²⁺, Pd²⁺ and Ru³⁺ were successfully extracted from aqueous or polar organic solutions into immiscible heptane solution of a PIB-bound thioether-thiol sequestrant. This PIB derivative demonstrated an excellent performance with quantitative metal complexation in many cases. This functional polymer is efficient even in the presence of competing ligands that are typically used in homogeneous catalysis. In addition, this sequestrant was successfully used for treatment of aqueous and polar organic solutions of crude product mixtures obtained in model Pd-catalyzed Suzuki cross-coupling and Buchwald-Hartwig amination reactions, as well as in a Cu(I)-catalyzed alkyne/azide cyclization (CuAAC) reaction.

The polymer-supported chelating agent will be better understood with reference to the following examples

### Example 1

### Synthesis of the Polymer-Supported Chelating Agent

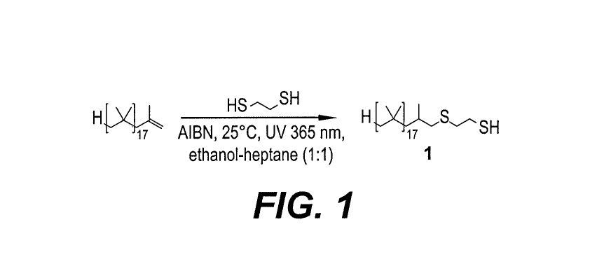

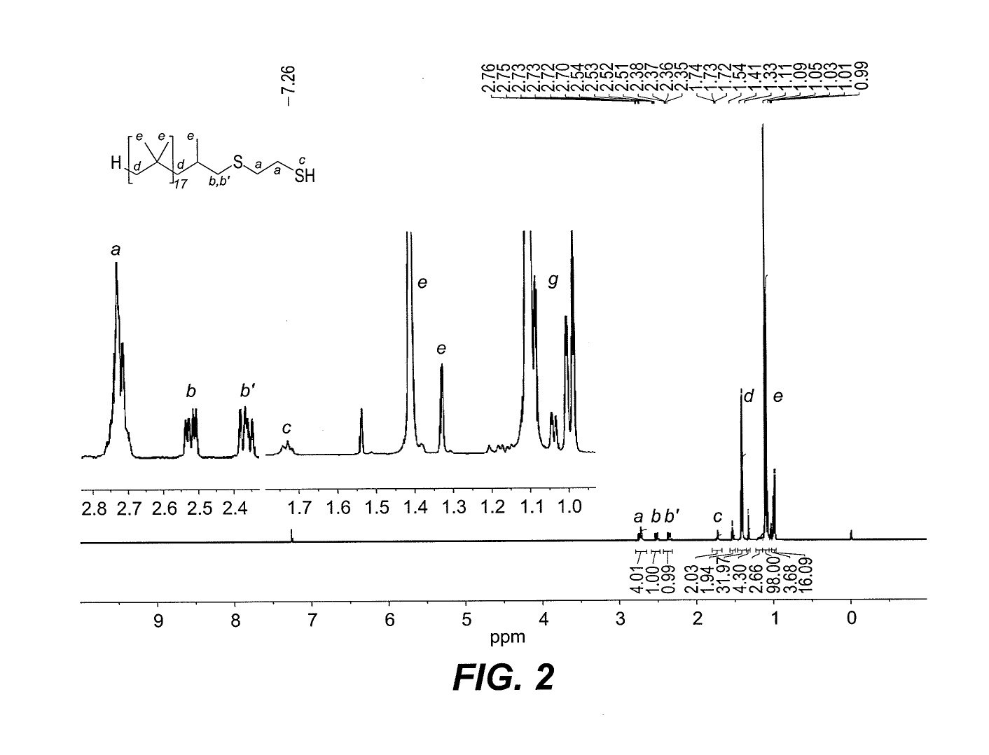

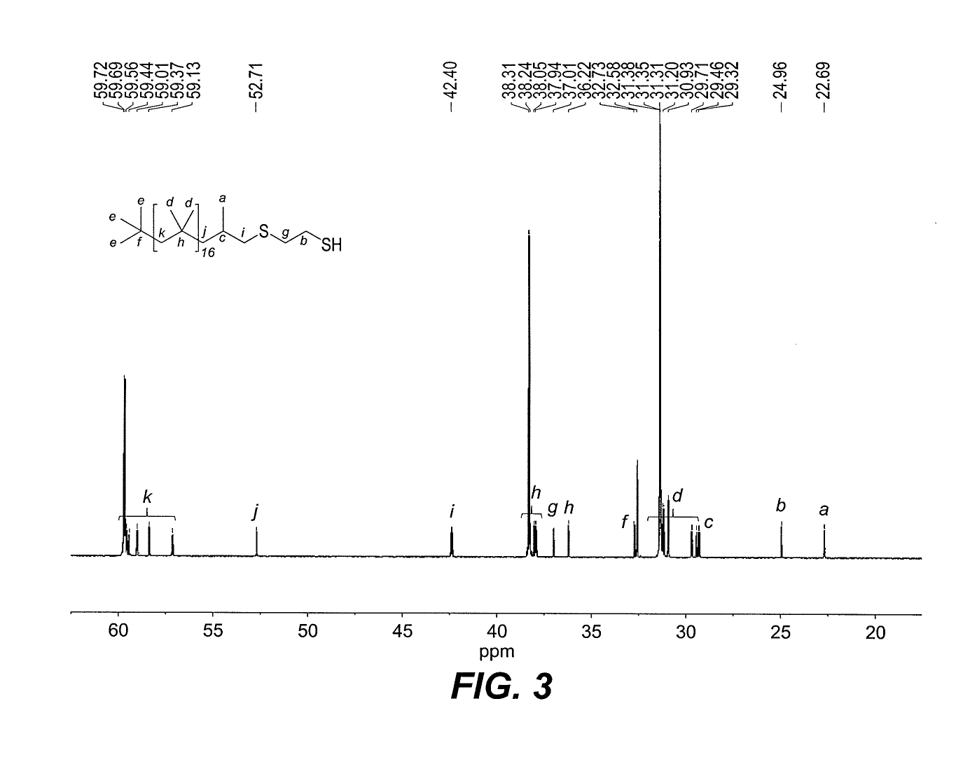

Dithiol-functionalized polybutadiene 1 was prepared via a green and simple single step radical thiol-ene “click” reaction between commercially available and inexpensive 1,2-ethanedithiol and alkene-terminated PIB Glissopal 1000 (DPₙ=18), as depicted in FIG. 1. The desired polymer 1 was obtained as clear viscous liquid in 92% yield and fully characterized by ¹H (see FIG. 2) and ¹³C NMR spectroscopy (see FIG. 3). As is true for other functionalized PIB derivatives, NMR spectroscopy makes it easy to characterize the products, since the signals of the PIB backbone appear in the 1.00-1.50 ppm region, whereas signals of the functional terminus are observed downfield, from 1.50 to 3.00 ppm. In our first attempts, thermal initiation with either 0.1 eq. of di-tert-butyl peroxide (DTBP) or azobisisobutyronitrile (AIBN) at 70° C. led to complete transformation of the PIB alkene in 24 h. However, in both cases, the desired thioether-thiol product 1 was contaminated with the bis-thioether 2 having the following structure:

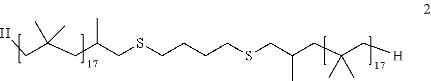

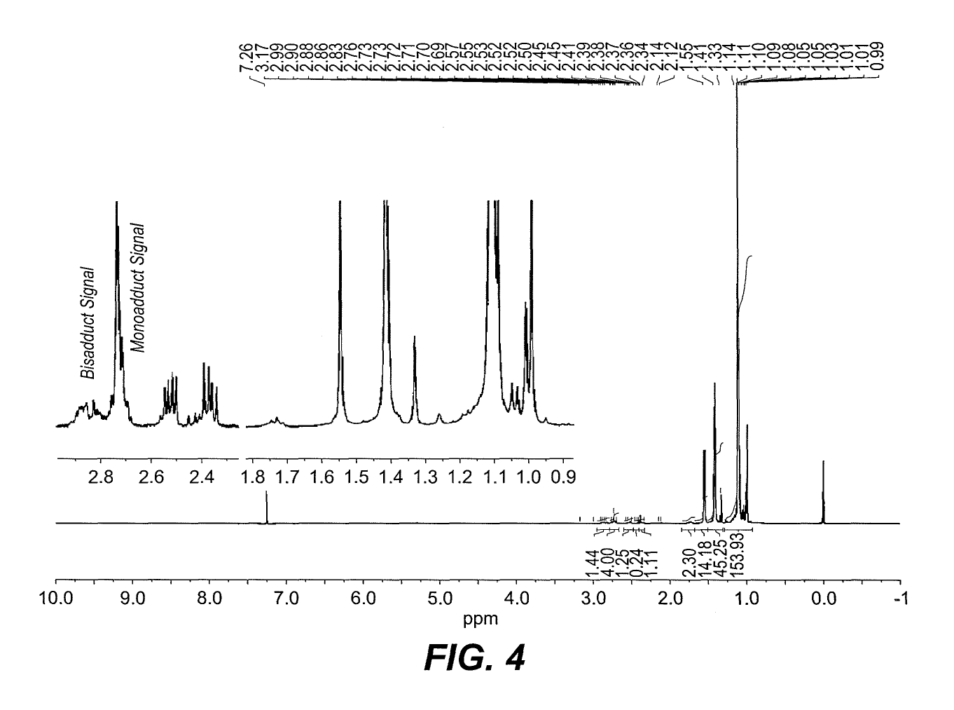

based on ¹H NMR spectroscopic analysis (see FIG. 4). Milder conditions using these initiators at 25° C. led to incomplete conversion. This problem was successfully addressed using photoinitiation with 365 nm UV light, which afforded quantitative conversion of the PIB-alkene in 8 h with negligible bis-adduct 2 formation.

### Example 2

### Proposed Mechanism of Action

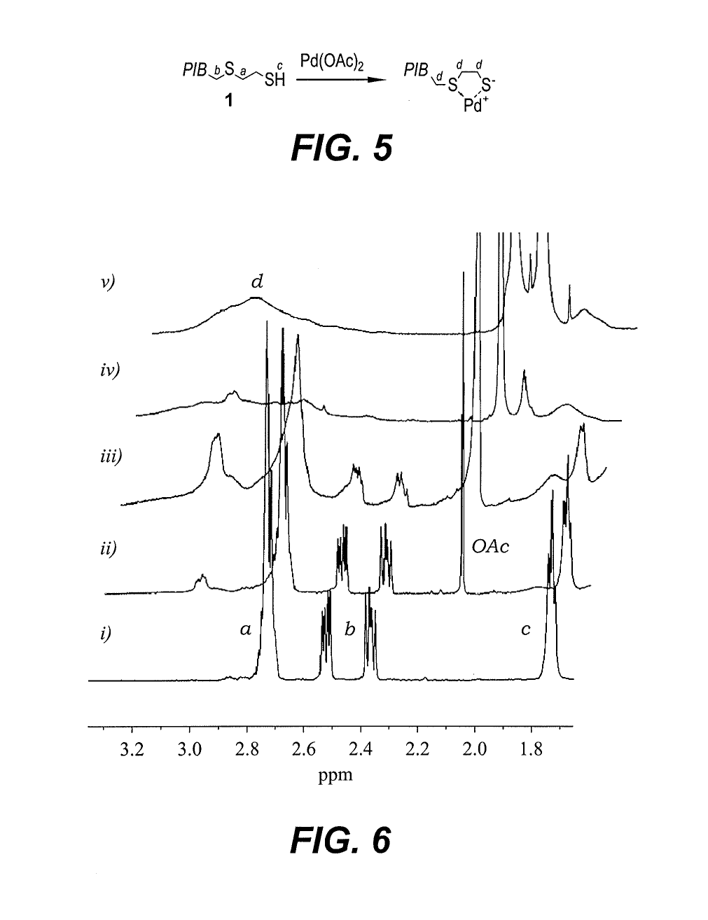

The PIB-bound sequestrant we prepared contains two different binding sites—thioether and thiol. They have differing complexation activity and affinity to transition metals. ¹H NMR spectroscopy titration of 1 with palladium acetate was used to understand better the complexation of 1 to Pd²⁺ (see FIG. 6). It led to a pronounced change in the chemical shift of the acetate protons from 2.00 ppm to 2.10 ppm that is characteristic for free acetic acid. Saturation was detected at equimolar [Pd²⁺]:[1] ratio by appearance of the signal of free palladium acetate complex. At this stage, signals of all three methylene groups adjacent to the sulfur atoms in 1 were shifted downfield with significant broadening, whereas the signal of the mercaptan hydrogen at 1.75 ppm disappeared, possibly due to proton exchange. These observations suggest chelation of Pd²⁺ with both coordination sites (see FIG. 5), similar to chelation with thioglycolic acid.

### Example 3

### Sequestering Transition Metals from Aqueous Solution and Polar Organic Solvent

A series of experiments were performed to determine the ability of 1 to sequester metals (in particular Cu²⁺ and Pd²⁺) from various polar solvents, including water. Our initial studies involved sequestration of transition metal cations such as Co²⁺, Ni²⁺, Cu²⁺, Pd²⁺ and Ru³⁺ from solutions of their salts in deionized water, methanol or acetonitrile by a heptane solution of 1. In a typical experiment, a solution of sequestrant in heptane was added to a solution of CuSO₄ in water and shaken, with resulting formation of an emulsion. Shaking was continued for 2 h. During this time, visually observed discoloration of the aqueous phase qualitatively indicated a high level of Cu²⁺ sequestration. Quantitative inductively coupled plasma optical emission spectroscopy (ICP-OES) analysis of the polar phase that indicated 60-fold decrease of copper content (Table 1) confirmed this observation. A control experiment with heptane that did not contain 1 did not result in any metal extraction, based on ICP-OES.

According to the results in Table 1, polymer 1 demonstrates good to excellent sequestration efficiency for a variety of transition metals under biphasic conditions. The best results were obtained for copper, palladium and ruthenium ions (Table 1, entries 5-13). In case of Co²⁺ and Ni²⁺ cations, sequestration efficiency for neutral solutions was modest, but it significantly increased under basic conditions. The same trend was observed for other metals. This observation can be explained by formation of poorly soluble metal hydroxides with enhanced affinity to sequestrant 1. Although 99.5% of palladium was absorbed from water solution in only 15 minutes, sequestration from acetonitrile required extended times to achieve the same efficiency. This observation is attributed to competitive complexation of Pd²⁺ cation by the acetonitrile.

TABLE 1
Metal sequestration by 1 under biphasic conditions

| | | | | Concentration, | | Sequestration |
|---|---|---|---|---|---|---|
| | | | Time, | ppm | | efficiency, |
| Entry | Metal | Solvent | h | initial | final | % |
| 1 | Co | water | 4 | 26.0 | 17.4 | 33.1 |
| 2 | | water ^{a} | 4 | 26.0 | 2.64 | 89.8 |
| 3 | Ni | water | 4 | 26.0 | 17.9 | 31.2 |
| 4 | | water ^{a} | 4 | 26.0 | 3.72 | 85.7 |
| 5 | Cu | water | 2 | 21.6 | 0.360 | 98.3 |
| 6 | | MeOH | 2 | 14.4 | 0.0250 | 99.8 |
| 7 | Ru | water | 4 | 26.0 | 1.02 | 96.1 |
| 8 | | water ^{a} | 4 | 26.0 | 0.0200 | 99.9 |
| 9 | Pd | water | 2 | 500 | 0.270 | 99.9 |
| 10 | | water | 0.25 | 22.5 | 0.120 | 99.5 |
| 11 | | water ^{a} | 1.5 | 26.8 | 0.0250 | 99.9 |
| 12 | | CH₃CN | 0.25 | 50.0 | 2.90 | 94.2 |
| 13 | | CH₃CN | 1.5 | 50.0 | 0.160 | 99.7 |

^{a} pH = 10

### Example 4

### Sequestering Palladium in Presence of Competitive Ligands

We also investigated whether a heptane solution of 1 could competitively sequester palladium species from polar organic solutions in the presence of other ligands that are commonly used in catalytic reactions. According to ICP-OES results (Table 2) high levels of Pd were sequestered by 1 in 4 h, in most cases. Sequestration efficiency tended to increase with time and generally exceeded 96%, except for samples where Pd was complexed by P(o-Anisyl)₃, P(o-Tolyl)₃, RuPhos, DPPF and Hermann's ligand. Even in those cases, around 90-95% of Pd could be removed with 1 if the extraction time was increased.

TABLE 2
Competitive sequestration of palladium
complexes from acetonitrile solutions

| | Concentration, ppm | | Efficiency, % | |
|---|---|---|---|---|
| Pd complex | in 4 h | in 12 h | in 4 h | in 12 h |
| (PPh₃)₂Pd(OAc)₂ | 0.620 | 0.39 | 98.8 | 99.2 |
| (P(o-Anisyl)₃)₂Pd(OAc)₂ | 6.36 | 3.17 | 87.3 | 93.7 |
| (P(o-Tolyl)₃)₂Pd(OAc)₂ | 6.03 | 1.94 | 87.9 | 96.1 |
| (PCy₃)₂Pd(OAc)₂ | 0.610 | 0.560 | 98.8 | 98.9 |
| (RuPhos)₂Pd(OAc)₂ | 9.24 | 2.01 | 81.5 | 96.0 |
| (DPPF)Pd(OAc)₂ | 10.2 | 2.67 | 79.5 | 94.7 |
| (DPEPhos)Pd(OAc)₂ | 2.08 | 1.02 | 95.8 | 98.0 |
| (XPhos)Pd(OAc)₂ | 0.820 | 0.440 | 98.4 | 99.1 |
| Pd₂(dba)₃ | 2.65 | 1.47 | 97.3 | 98.5 |
| (C₆H₅CN)₂PdCl₂ | 0.430 | 0.430 | 99.3 | 99.1 |
| (CH₃CN)₂PdCl₂ | 0.310 | 0.190 | 99.4 | 99.6 |
| Herrmann's catalyst | 8.05 | 5.19 | 83.9 | 89.6 |

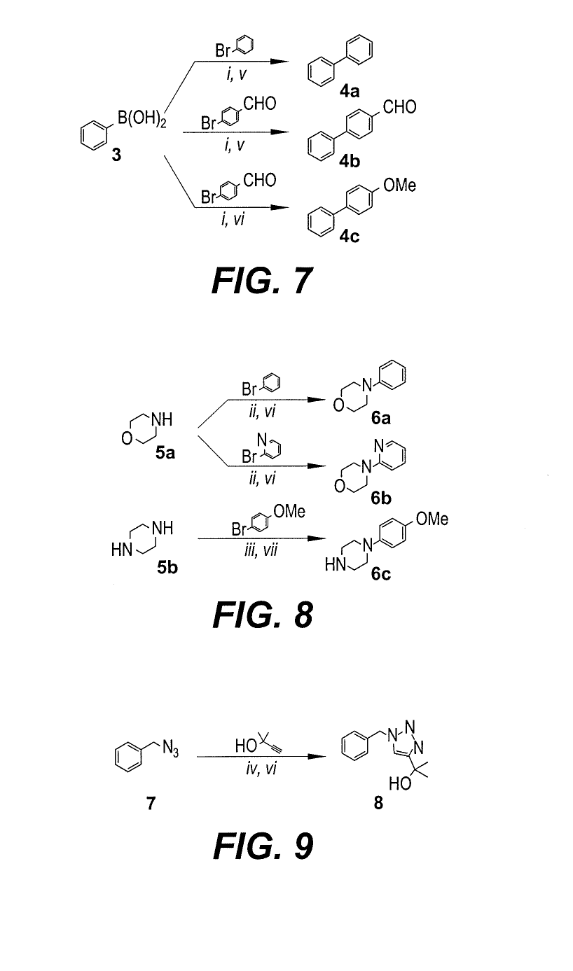

Metal sequestration is often important in catalytic reactions where the catalysts end up in a product phase. Our results in Tables 1 and 2 suggest that the soluble polymer bound sequestrant 1 should be useful in these cases. To explore this question, we decided to investigate the use of 1 for removal of the Pd residues from Suzuki cross-coupling (see FIG. 7) and Buchwald-Hartwig amination reactions (see FIG. 8). Similar studies were also carried out for a CuAAC reaction (see FIG. 9). In FIG. 7, the reaction conditions included (i) 1 eq. ArBr, 0.025 eq. Pd(OAc)₂, 0.05 eq. P(o-Anisyl)₃, 2 eq. K₂CO₃, toluene, 110° C., 12 h; (v) 1, MeOH/heptane; and/or (vi) 1, DCM/heptane/MeOH. In FIG. 8, the reaction conditions included (ii) 1.05 eq. ArBr, 0.01 eq. Pd(OAc)₂, 0.02 eq. RuPhos, 1.2 eq. t-BuONa, neat, 110° C., 12 h; (iii) 0.9 eq. ArBr, 0.01 eq. Pd₂(dba)₃, 0.015 eq. rac-BINAP, 1.5 eq. t-BuONa, toluene/THF, 100° C., 12 h; (vi) 1, DCM/heptane/MeOH; and/or (vii) 1, acetonitrile/heptane. In FIG. 9, the reaction conditions included (iv) 1 eq. alkyne, 0.15 eq. CuSO₄.5H₂O, 0.45 eq. sodium ascorbate, DCM/H₂O, 25° C., 3 h; and (vi) 1, DCM/heptane/MeOH.

### Example 5

### Sequestering Suzuki Cross-Coupling Catalyst

Reaction of phenyl boronic acid 3 with different substituted bromoarenes under typical coupling conditions described above using 2.5 mol % of Pd(OAc)₂ afforded biaryls 4a-4c in toluene (FIG. 7). The crude products 4a,4b (dark brown) contained 275 ppm of Pd as measured by ICP-OES. However, when the crude products were dissolved in MeOH and shaken for 4 h with a 6-fold excess of 1 in a heptane solution, complete discoloration of the MeOH phase was observed. Quantitative ICP-OES analysis of the treated product showed that the Pd concentration decreased by 99.9% (Table 3). However, in the case of the reaction leading to 4c, the Pd recovery under the same conditions was not as efficient. A separate experiment when 1 was allowed to interact with the crude product mixture under homogeneous conditions afforded quantitative Pd sequestration. In this case the crude 4c was mixed with a 6-fold excess of 1 in DCM (dichloromethane) and stirred at ambient temperature for 2 h. After the solvent removal, the desired 4-methoxybisphenyl 4c was isolated by liquid-liquid fractionation in MeOH-heptane 1:1 (v/v) mixture.

TABLE 3
Palladium/copper sequestration from model reaction mixtures

| | Metal concentration, ppm | | Sequestration |
|---|---|---|---|
| Substrate | Crude | treated | efficiency, % |
| 4a | 275 | 0.170 | 99.9 |
| 4b | 275 | 0.180 | 99.9 |
| 4c | 275 | 0.230 | 99.9 |
| 6a | 171 | 1.25 | 99.3 |
| 6b | 246 | 0.130 | 99.9 |
| 6c | 290 | 63.2^{a} | 78.2^{a} |
| 6c | 290 | 9.01^{b} | 96.9^{b} |
| 8 | 727 | 0.300 | 99.9 |

^{a}at 25° C.;
^{b}at 80° C.

### Example 6

### Sequestering Buchwald-Hartwig Amination Reaction Catalyst

Bromobenzene and 2-bromopyridine were successfully coupled to morpholine under neat conditions using 1 mol % of Pd(OAc)₂ and RuPhos as a ligand to afford compounds 6a,6b (see FIG. 8). Again, a high level of removal of the Pd residues from the final product was achieved under biphasic conditions. A third example of this reaction that led to formation of N-(4-anisyl)piperazine 6c was slightly less successful and afforded only 63% of Pd sequestrated at ambient temperature. Similar to the situation with methoxybisphenyl 4c, such a poor sequestration efficiency is a result of modest solubility of the crude product in the solvent mixture. In this case, heating the biphasic mixture of the acetonitrile solution of the product 6c and the heptane solution of 1 at 80° C. for 4 h led to 96.9% sequestration of the Pd catalyst residues (see Table 3).

### Example 7

### Sequestering Cu(I)-Catalyzed Alkyne/Azide Cyclization Reaction Catalyst

The azide-alkyne “click” reaction between benzyl azide 7 and dimethyl ethynyl carbinol in the presence of 15 mol % of Cu led to formation of a triazole 8. Copper sequestration afforded nearly 2500-fold reduction of the residual Cu amount in the reaction product (Table 3) that corresponds to more than 99.9% efficiency.

The results obtained in these experiments show that a heptane-soluble, PIB-bound thioether-thiol metal scavenger is easy to synthesize and is generally highly effective at removing metals from aqueous or polar organic solutions under biphasic conditions. In many cases, this sequestrating agent removes >99% of the metal from the aqueous or polar organic phase. This material is successful at metal sequestration even when there are other ligands present and can be used for the treatment of crude reaction mixtures following catalytic reactions. Even in cases where the sequestration is not initially quantitative, minor experimental changes are effective in producing near quantitative metal sequestration.

It is to be understood that the polymer-supported chelating agent is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A polymer-supported chelating agent, comprising polyisobutylene having a terminal group, the terminal group being a chelating agent.

2. The polymer-supported chelating agent according to claim 1, wherein the chelating agent comprises a thiol-thioether.

3. The polymer-supported chelating agent according to claim 1, having the formula:

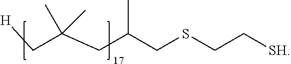

4. A method of synthesizing the polymer-supported chelating agent according to claim 3, comprising the steps of:
dissolving alkene-terminated polyisobutylene and 1,2-ethanedithiol in a solvent mixture of ethanol and heptane, the solvent mixture being 1:1 ethanol:heptane volume-to-volume to form a reaction mixture;
adding a polymerization initiator to the reaction mixture; and
irradiating the reaction mixture with ultraviolet light.

5. The method of synthesizing the polymer-supported chelating agent according to claim 4, wherein said polymerization initiator comprises azobisisobutyronitrile (AIBN).

6. The method of synthesizing the polymer-supported chelating agent according to claim 4, wherein said polymerization initiator comprises di-tert-butyl peroxide (DTBP).

7. The method of synthesizing the polymer-supported chelating agent according to claim 4, wherein said step of irradiating the reaction mixture with ultraviolet light comprises irradiating the reaction mixture with ultraviolet light at a wavelength of 365 nm.

8. The method of synthesizing the polymer-supported chelating agent according to claim 4, wherein said step of irradiating the reaction mixture with ultraviolet light at a wavelength of 365 nm is performed at 25° C.

9. A method of removing a transition metal from a polar solvent using the polymer-supported chelating agent according to claim 3, comprising the steps of:
dissolving at least a stoichiometric quantity of the polymer-supported chelating agent according to claim 3 in an extraction solvent;
mixing the extraction solvent with a polar solvent having the transition metal in solution to selectively extract the transition metal into the extraction solvent by chelation of the transition metal;
waiting for the extraction solvent and the polar solvent to separate into a nonpolar phase and a polar phase; and
separating the nonpolar phase from the polar phase, the polymer-supported chelating agent having the transition metal chelated thereto being selectively solvated in the nonpolar phase.

10. The method of removing a transition metal from a polar solvent according to claim 9, wherein said extraction solvent comprises heptane.

11. The method of removing a transition metal from a polar solvent according to claim 9, wherein said extraction solvent comprises dichloromethane.

12. The method of removing a transition metal from a polar solvent according to claim 9, wherein said mixing step further comprises heating the mixed extraction and polar solvents at 80° C.

13. The method of removing a transition metal from a polar solvent according to claim 9, wherein said at least stoichiometric quantity comprises a six-fold excess of the polymer-supported chelating agent according to claim 3.

14. A method of synthesizing a polymer-supported chelating agent, comprising the steps of:
dissolving alkene-terminated polyisobutylene and 1,2-ethanedithiol in a solvent mixture of ethanol and heptane, the solvent mixture being 1:1 ethanol:heptane volume-to-volume to form a reaction mixture;
adding a polymerization initiator to the reaction mixture; and
irradiating the reaction mixture with ultraviolet light at a wavelength of 365 nm.

15. The method of synthesizing the polymer-supported chelating agent according to claim 14, wherein said polymerization initiator comprises azobisisobutyronitrile (AIBN).

16. A method of recovering a transition metal of a transition metal catalyst from a spent reaction mixture, comprising the steps of:
dissolving a six-fold excess over a stoichiometric quantity of a polymer-supported chelating agent having the formula: 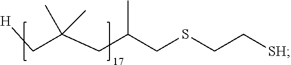
into a nonpolar organic solvent to form an extraction solvent;
adding a polar solvent to the spent reaction mixture containing the transition metal catalyst, the transition metal catalyst being soluble in the polar solvent, in order to form a polar phase;
mixing the extraction solvent with the polar phase having the transition metal in solution to selectively extract the transition metal into the extraction solvent by chelation of the transition metal;
waiting for the extraction solvent and the polar solvent to separate into a nonpolar phase and a polar phase; and
separating the nonpolar phase from the polar phase, the polymer-supported chelating agent having the transition metal chelated thereto being selectively solvated in the nonpolar phase to recover the transition metal of the transition metal catalyst.

17. The method of recovering a transition metal catalyst according to claim 16, wherein said nonpolar organic solvent comprises heptane.
